(19) United States
(12) Patent Application Publication
(10) Pub. No.: US 2026/0352515 A1
(43) Pub. Date: Nov. 5, 2026

(54) VIRTUAL SWITCH FORMAT CONVERSIONS IN HYPERVISOR ENVIRONMENTS

(71) Applicant: International Business Machines Corporation, Armonk, NY (US)

(72) Inventors: Dennis Ray Musselwhite, Hallstead, PA (US); Richard P. Tarcza, Kingston, NY (US); Walter Church, IV, Scotch Plains, NJ (US); Montana Alexandra Lee, Wappingers Falls, NY (US); Stephen Glenn Wilkins, Endicott, NY (US); Margaret Ann Williams, Warren Center, PA (US); Susan Marie Farrell, Binghamton, NY (US)

(21) Appl. No.: 19/084,215

(22) Filed: Mar. 19, 2025

(51) Int. Cl. H04L 12/54

(52) U.S. Cl. CPC H04L 12/56; H04L 2012/5617; H04L 2012/562

(57) ABSTRACT

A virtual switch that can handle routing of data packets among source and destination utilizing different types of input/output architecture is provided. A virtual switch receives an interrupt that signals the virtual switch to process a data packet that is input to the virtual switch. The virtual switch allocates a data buffer in a memory space associated with the virtual switch. The virtual switch creates a message block data structure. The virtual switch determines a destination device for the data packet. Based on a type of input/output architecture processed by the destination device, the virtual switch automatically adapts the internal structure of the data packet to conform to a requirement of the destination device, using the allocated data buffer and the message block data structure.

### BACKGROUND

The present application relates generally to computers and computer networks, and more particularly to a virtual switch network.

### BRIEF SUMMARY

The summary of the disclosure is given to aid understanding of a computer system and method of virtual switch format conversions in hypervisor environments, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

In some embodiments, a computer-implemented method can provide for virtual switch format conversions in hypervisor environments. The computer-implemented method includes receiving an interrupt that signals a virtual switch to process a data packet that is input to the virtual switch. The computer-implemented method also includes allocating a data buffer in a memory space associated with the virtual switch. The computer-implemented method also includes creating a message block data structure. The computer-implemented method also includes determining a destination device for the data packet. The computer-implemented method also includes, responsive to determining that the destination device processes data packets without headers, copying a payload of the data packet without header information into the data buffer offset by a predetermined byte size, and inserting an address of the data buffer offset by the predetermined byte size into the message block data structure. The computer-implemented method also includes, responsive to determining that the destination device processes data packets with headers, inserting header information associated with the data packet into the data buffer at the starting address of the data buffer, copying the payload of the data packet into the data buffer offset by the predetermined byte size, and inserting the address of the data buffer into the message block data structure. The computer-implemented method also includes queuing the message block data structure into a processing queue of the virtual switch. The computer-implemented method also includes signaling the destination device to route the data packet by processing the message block data structure in the processing queue.

In some embodiments, a computer system is provided. The computer system includes processor set. The computer system also includes a set of one or more computer-readable storage media. The computer system includes program instructions, collectively stored in the set of one or more computer-readable storage media, for causing the processor set to perform the following computer operations: receiving an interrupt that signals a virtual switch to process a data packet that is input to the virtual switch; allocating a data buffer in a memory space associated with the virtual switch; creating a message block data structure; determining a destination device for the data packet; responsive to determining that the destination device processes data packets without headers, copying a payload of the data packet without header information into the data buffer offset by a predetermined byte size, and inserting an address of the data buffer offset by the predetermined byte size into the message block data structure; responsive to determining that the destination device processes data packets with headers, inserting header information associated with the data packet into the data buffer at the starting address of the data buffer, copying the payload of the data packet into the data buffer offset by the predetermined byte size, and inserting the address of the data buffer into the message block data structure; queuing the message block data structure into a processing queue of the virtual switch; and signaling the destination device to route the data packet by processing the message block data structure in the processing queue.

In some embodiments, a computer program product comprising a set of one or more computer-readable storage media, and program instructions, collectively stored in the set of one or more storage media, for causing a processor set to perform computer operations that perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement virtual switch input/output queue data conversion in some embodiments.

FIG. 2 shows a data layout for data packets or datagrams in some embodiments.

FIG. 3 is a diagram illustrating a virtual switch processing that handles different architectures in some embodiments.

FIG. 4 is a block diagram illustrating a virtual switch network in some embodiments.

FIG. 5 is a flow diagram illustrating a method in some embodiments.

FIG. 6 is a flow diagram illustrating a virtual switch processing flow in some embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk drive (HDD), random access memory (RAM), read-only memory (ROM), erasable programmable read-only memory (EPROM or Flash memory), static random access memory (SRAM), compact disc read-only memory (CD-ROM), digital versatile disk (DVD), direct access storage device (DASD), solid-state drive (SSD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as virtual switch code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

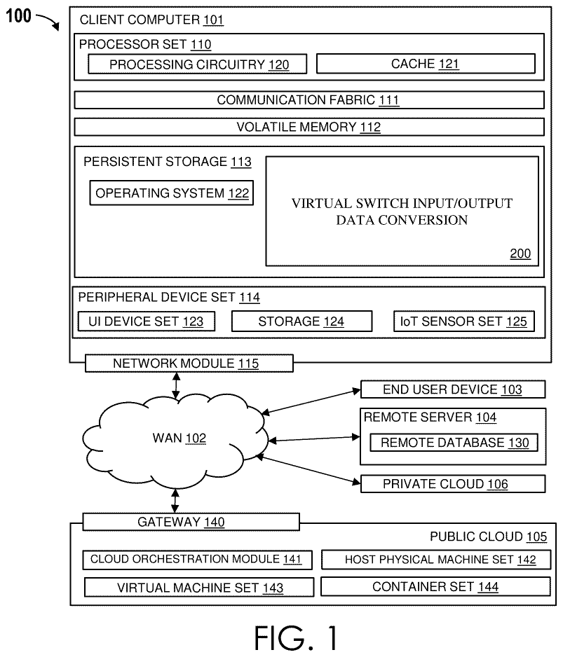

COMPUTER 101 may take the form of a desktop computer, laptop computer, tablet computer, smart phone, smart watch or other wearable computer, mainframe computer, quantum computer, distributed computer system, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A virtual switch (VSWITCH) allows virtual machines (VMs) to communicate with each other and with physical networks. A VSWITCH can be implemented as software program or firmware. For example, a hypervisor or a computer processor that controls virtual machines can operate to perform functions of a VSWITCH. A VSWITCH emulates a network switch, connects virtual machines to one another, and connects virtual machines to physical networks. Briefly, for example, virtual switches allow virtual machines to access and operate on Ethernet networks.

Virtual switch (VSWITCH) implementations can be based on different input/output queue architecture. Some implementations may not be compatible with one another. For example, currently, VSWITCH implementations that are based on queued direct input/output (QDIO) architecture are not directly compatible with a new architecture such as enhanced queued direct input/output (EQDIO) architecture.

For example, each network packet is represented within the virtual switch as a block structure, e.g., a network device message block (NDMBK) structure, with one or more memory buffers beginning with a formatted QDIO header. NDMBK functions to define a structure to represent a network device message. One NDMBK exists to represent each message frame created for a Network Interface Device (NID). EQDIO is a new architecture, using a new method of sending data through the network without packet headers.

QDIO is a highly efficient data transfer architecture, which dramatically improves data transfer speed and efficiency for Transmission Control Protocol/Internet Protocol (TCP/IP) traffic. Some advantages of using QDIO mode include: A 20% improvement in performance versus non-QDIO mode; The reduction of system assist processor (SAP) utilization; Improved response time server cycle reduction.

An implementation of a VSWITCH supporting architecture that includes a formatted QDIO header, creates a discrete virtual switch network hub that would exchange network packets (e.g., NDMBK structures) with buffers that begin with a formatted QDIO header. However, hosts that use a different format or architecture are not able to communicate directly with one another via such VSWITCH implementation. For example, hosts with one format are prevented from communicating with hosts with a different format, and vice versa. For instance, while QDIO mode uses packet headers, EQDIO mode can send data through the network without packet headers. Hence, compatibility issues exist among devices that support different architectures.

In some embodiments, one or more techniques disclosed herein emulate a virtual switch network based on one architecture (e.g., EQDIO), and support interoperability with guest device drivers based on another architecture (e.g., QDIO format). The techniques may provide such interoperability support with much efficiency, e.g., such that performance of a network on one architecture is not slowed down.

In some embodiments, a VSWITCH design and implementation, and methods thereof, are provided that allow hosts or guests using different architectures (e.g., EQDIO and QDIO) to be able to directly communicate or “talk” to one another in a same network. Hosts or guests refer to virtual machines.

For example, one or more techniques disclosed herein enables hosts or virtual machines using QDIO architecture to communicate directly within the same virtual switch instance with hosts or virtual machines using EQDIO architecture, and vice versa. One or more techniques disclosed herein also enables hosts or virtual machines using either architecture (QDIO or EQDIO) to communicate with an external network via either uplink (trunk) port hardware (QDIO or EQDIO).

An enhancement to a virtual switch supports both EQDIO and QDIO network interface cards in the same virtual switch network. For example, user devices supporting different types of queued direct input output schema can be connected to the same virtual switch network. A VSWITCH front-end can be connected to user devices. Any reasonable number of user devices can be connected. User virtual machines can be built with a network device that emulates QDIO or EQDIO architecture depending on the software requirements of that user. VSWITCH backend can connect EQDIO to real hardware, e.g., an Open Systems Adapter Hybrid (OSH) device, or real hardware can be connected to an Open Systems Adapter (OSA), a network adapter, which uses QDIO architecture. VSWITCH allows any user device connection to pass through to real EQDIO hardware. In some embodiments, VSWITCH can connect to devices supporting either type of architecture, e.g., QDIO or EQDIO, and also to hardware that supports either type of architecture. The user device architecture does not have to match the backend device architecture at the time of transfer.

In some embodiments, a virtual switch reads the new EQDIO datagrams from a storage block page entries and builds a block structure, e.g., NDMBK, that are processed throughout the virtual switch by generating a new QDIO header. A packet (an EQDIO datagram) is moved into a data buffer to hold the contents and a header is created in the first predetermined of bytes, e.g., x20 bytes, for that EQDIO datagram.

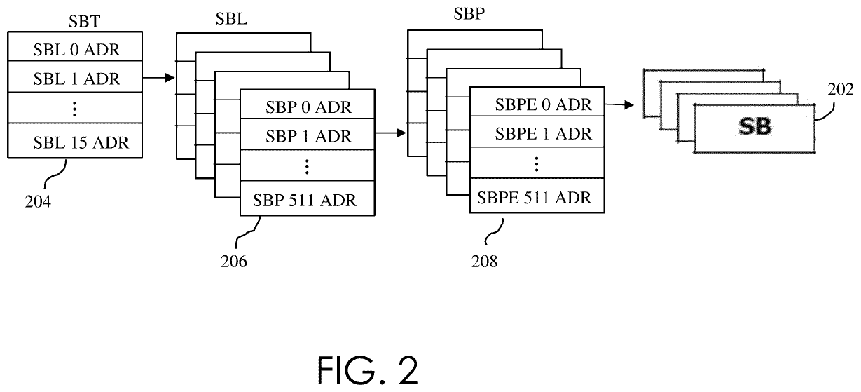

FIG. 2 shows a data layout for data packets or datagrams in some embodiments. In this example layout, an actual data packet or datagram is contained in a storage block (SB) 202. This storage block 202 is accessed via layers of addressability. For instance, a processor or controller accesses a storage block table (SBT) 204, which stores indices or address entries, addressing or pointing to entries in storage block list (SBL) 206. An address entry in the storage block table 204 points to an entry in a storage block list 206. A storage block list 206 stores address entries addressing or pointing to entries in a storage block page (SBP) 208. An address entry in the storage block list 206 points to an entry in a storage block page 208. A storage block page 208 stores address entries addressing or pointing to a storage block 202. An address entry in the storage block page 208 points to a storage block 202, which stores the content of the actual data packet. For instance, every storage block page entry (SBPE) points to a storage block (SB) 202 page. There can be multiple SBLs 206, each of which can store or contain multiple SBP address entries. There can be multiple SBPs 208, each of which can store or contain multiple SBPEs. An SBPE points a storage block 202 page.

A virtual switch, e.g., a processor or controller that controls or performs operations of a virtual switch or a virtual machine server, accesses a data packet or datagram stored on a storage block 202, for example, via layers of addressability described above, for example, starting with a storage table 204. For the data packet, the virtual switch determines or identifies its destination. If the destination is within the same virtual switch network, then the virtual switch passes the data packet internally. Otherwise, if the destination is outside of, or external to, the virtual switch network, the virtual switch builds a control block or network message block (NDMBK), a data structure, and places that data structure on a virtual switch's processing queue or EQDIO processing queue. The virtual switch allocates a new data buffer, copies the data packet stored on the SB page into the new data buffer starting at an offset, e.g., offset of hex 20 (x20) bytes into the new data buffer, e.g., a new data buffer page, and stores the address of the new data buffer page into the NDMBK block that is built and placed on the processing queue.

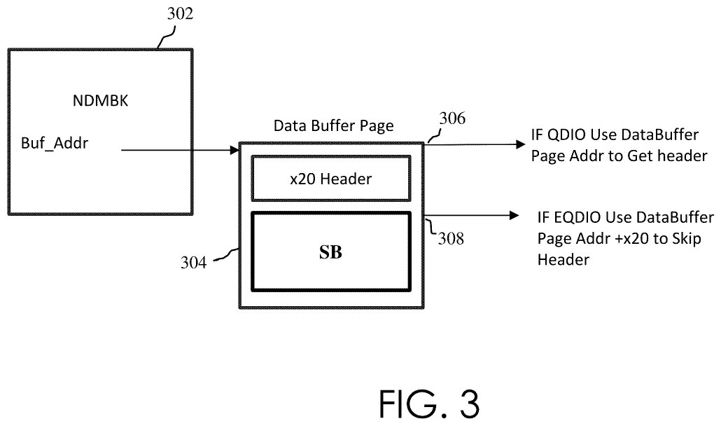

FIG. 3 is a diagram illustrating a virtual switch processing that handles different architectures in some embodiments. A virtual switch monitors a processing queue (e.g., SB block at 202 in FIG. 2). If a packet to route exists in the processing queue, processing of the packet starts. A virtual switch builds a data structure referred to as a message block structure 302. Such data structure is also referred to as NDMBK as described above. Such data structure resides in a memory space associated with the virtual switch. The virtual switch also allocates a new data buffer (also referred to as a new data buffer page) 304 in a memory space associated with the virtual switch. The new data buffer is allocated with a buffer address that points to the beginning (or top) 306 of that data buffer. A data space of a predetermined byte size, e.g., x20 (x20), is reserved for a header at the top of the data buffer, for architecture or data packets that use a header format. The virtual switch, when copying the data of the packet, copies the data of the packet (e.g., payload) at the offset of x20 308. A payload portion of a data packet contains data or information being communicated between a source machine and a target machine. A header portion of a data packet, if there is a header in a data packet, may contain information about the data packet such as but not limited to a protocol type, a checksum for error detection, packet or message sequence number, and/or other information.

Having an offset allows the virtual switch to have a header that supports QDIO architecture even if the packet is in the format of EQDIO architecture, which does not use a header. For instance, if the destination (e.g., backend hardware) expects the format of the data packet to be in QDIO format, the header (possibly generated by VSWITCH) is transferred to the backend device along with the payload. For example, the data packet's payload is copied at the offset of x20 with its header copied or generated starting at the top of the buffer. If the destination (e.g., backend hardware) expects the format of the data packet to be in EQDIO format, the data packet's payload is copied at the offset of x20 of the new data buffer. The address that the NDMBK points to, which is queued in a virtual switch's processing queue, for EQDIO format packet is the new data buffer address offset by an offset, e.g., x20 (new data buffer address+x20). The address that the NDMBK points to, which is queued in a virtual switch's processing queue, for QDIO format packet is the new data buffer address. The new data buffer or buffer page is used as a storage block for real hardware. This allows a header to always be available but not passed to the real EQDIO OSH hardware. For example, at the backend, the virtual switch is able to provide the data packet to the hardware, according to the hardware device's implementation, e.g., EQDIO or QDIO. For example, a hardware device that expects an EQDIO format receives an address that is a data buffer address plus an offset amount, e.g., x20, as the start address that stores the data packet, and does not see any header information, as would be compatible for that type of device; a hardware device that expects a QDIO format receives a data buffer address, sees a header information, as would be compatible for that type of device.

For example, the data buffer page address at the location where the storage block data starts, for QDIO format, is the entire data buffer page that is allocated, where a header is generated to match the QDIO format, even if the data packet was in EQDIO format as an input. The data buffer page address at the location where the storage block data starts, for EQDIO format is the data buffer address offset by an offset, e.g., x20. The virtual switch, thus, performs intermediate processing for an input data packet from a virtual machine (also referred to as a host or guest), before passing the input data packet to the hardware at the backend of the virtual switch. The virtual switch allows any virtual machine connection to pass through to real EQDIO hardware.

In this way, EQDIO packets are converted or transformed to a base format that is compatible with existing QDIO packets. Depending on the trunk port (outgoing hardware device) all the NDMBKs are processed and the data converted. If the device is OSH, then the header is removed by using the buffer page address+offset bytes, e.g., x20 bytes. Otherwise, if the trunk port is OSA (QDIO) then the whole data buffer page can be used. This special processing allows the virtual switch to efficiently handle EQDIO packets in the network with QDIO packets.

A host with an EQDIO OSH (adapter card) can take advantage of the EQDIO capabilities it enables, while still virtualizing itself as a QDIO device to any guests that may not be able to understand or process EQDIO. This allows QDIO and EQDIO guests to be connected to the same virtual switch and use the new EQDIO OSH real hardware underpinning the virtual switch connection. This is done through a virtual switch interface. For QDIO devices that are attached to a virtual switch that has EQDIO as the output adapter, any packets flowing through the network are intercepted and properly processed.

In some embodiments, all packets are processed from a guest queue and placed into a Network Device Message Data (NDMData) buffer (located within the Network Device Message Data Block (NDMBK), e.g., an NDMBK contains data and a field within that is NDMData that points to a page containing the packet data being copied). This buffer copies the packet contents at an offset, e.g., offset x20, which creates header bytes, e.g., a 32-byte header, in the beginning of the buffer. This header is compatible with the QDIO format. The header area is filled in for the required data by inspecting the EQDIO packet. If malformed or needed data does not exist then the packet is immediately discarded. Otherwise, the new header is filled in with information relating to the packet such as the destination Media Access Control (MAC), the type (Unicast, Multicast, Broadcast), payload length, and/or other information.

The NDMBK is placed on a processing queue for the EQDIO output adapter (real OSH).

The processing queue is harvested and if the destination MAC is part of the virtual switch, then the NDMBK can be given directly to the guest. If the output adapter is EQDIO then the SB address placed into the storage block page entry (e.g., FIG. 2 at 208) is the buffer address+x20 (or offset). This allows the headers to be stripped or removed for the EQDIO format. In some embodiments, this also allows a virtual machine to use the header for extra data. If the output adapter is QDIO then the whole buffer page is placed into the storage block address list.

In some embodiments, a virtual switch may provide compacting of storage blocks (e.g., FIG. 2 at 202). A virtual switch may have several guests (e.g., virtual machines) sending data through network. In some embodiments, all the SB pages from the guests are copied to buffers pointed by NDMBK blocks. An NDMBK block includes an address to an allocated data buffer that stores the packet payload; An NDMBK block also may contain metadata (information) about the packet. In some embodiments, if the data contained within an SB is not a full page, then more data can be moved in. In some embodiments, NDMBKs can be queued based on data length. For instance, data length is described as follows. “Full”: Len>3048 bytes; “Upper Half”: 3048 bytes>=Len>2032 bytes; “Lower Half”: 2032 bytes>=Len>1016 bytes; “Small”: Len<=1016 bytes. Upper Half data length can fit one Small data length; Lower Half data length can fit two small data lengths. For instance, multiple data packets can be merged into one storage block, based on the packet sizes.

The techniques disclosed herein allows hosts using format of QDIO architecture to communicate directly (within the same virtual switch instance) with hosts using EQDIO architecture, and vice versa; allows hosts using either architecture (QDIO or EQDIO) to communicate with the external network via either uplink (trunk) port hardware (QDIO or EQDIO). The techniques described herein allow interoperability between QDIO hosts and EQDIO hosts. Virtual machines need not change any existing QDIO infrastructure for compatibility with EQDIO format. EQDIO packets can be sent to QDIO networks, and vice versa. A single virtual switch can handle both messages or data packets that have QDIO and EQDIO architecture formats.

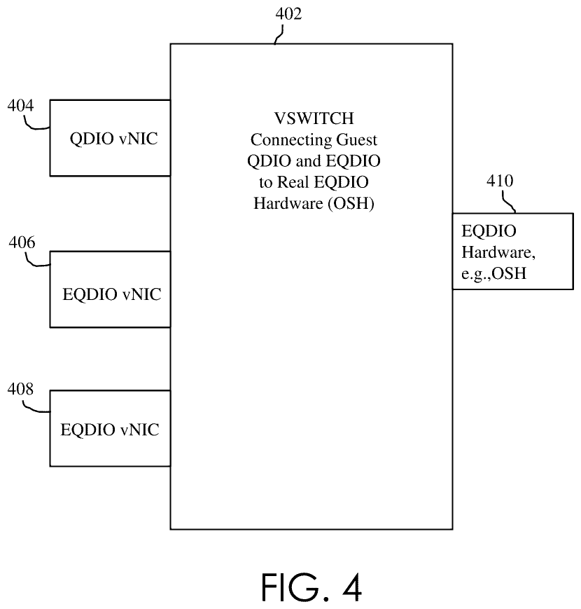

FIG. 4 is a block diagram illustrating a virtual switch network in some embodiments. Block at 402 represents a virtual switch and its processing, e.g., virtual switch network. A virtual switch 402 connects guest QDIO 404 and guest EQDIO 406, 408 to real EQDIO hardware 410. For example, a virtual switch 402 performs the following functions or processing. QDIO virtual network interface card (vNIC) 404 and EQDIO vNIC 406, 408 can be considered as guests (e.g., virtual machines) connected to the virtual switch 402. At the backend, a hardware 410 such as an adapter is connected to the virtual switch 402, which takes data packets input from the guests (e.g., 404, 406, 408). The virtual switch 402 processes data packets coming in from one or more of QDIO vNIC 404 and EQDIO vNIC 406, 408. For example, the virtual switch 402 parse through a memory block or page for data packets. An example of a memory block or page, which the virtual switch 402 parses, is a storage block shown in FIG. 2 at 202. For example, a processing queue (e.g., of memory blocks or storage blocks) for the virtual switch 402 contains data packets for processing. If the data packet is destined for the current network, it is treated as an internal data packet, and the virtual switch 402 passes the internal data packet within the network without further processing to its destination. If the data packet is destined for an external network, the virtual switch 402 determines the data packets type, e.g., whether it is one that uses a header (e.g., QDIO) or no headers (e.g., EQDIO). The type of data packet is generally provided in the hardware, and there can be flags that specify what type an incoming data packet is. For instance, the virtual switch 402 checks for destination of an incoming data packet, and if the incoming data packet is destined for a hardware device implementing EQDIO architecture (e.g., 410), e.g., no header information in the data packet, the virtual switch 402 strips or removes any QDIO headers (e.g., if the incoming data packet came in with a QDIO header). If the incoming data packet is destined for a hardware device implementing QDIO architecture, e.g., one that uses a header, the virtual switch generates a header for that incoming data packet. The virtual switch 402 forms or creates a message block data structure (e.g., NDMBK block) which holds a buffer address that contains the payload of the data packet, and places the message block data structure (e.g., NDMBK block) on processing queue. For example, the virtual switch packs its storage block with message block data structure. If processing of the processing queue by destination hardware at the back-end (or backend) has not started, the virtual switch starts the processing of the processing queue, for example, provide an instruction to hardware to start processing the queue.

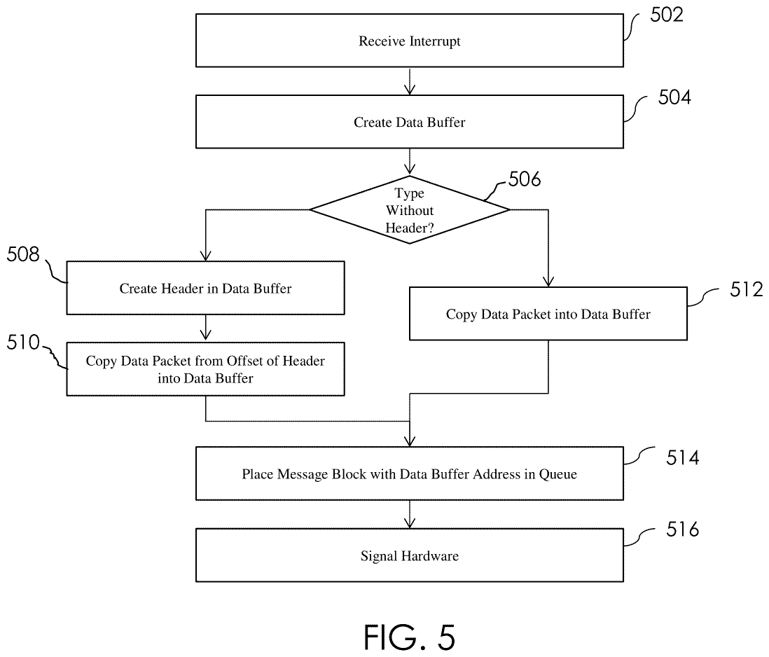

FIG. 5 is a flow diagram illustrating a method in some embodiments. The method allows multiple device types to connect to same virtual switch. At 502, a virtual switch receives an interrupt signal to process a queue. The queue contains data packets, e.g., received from one or more virtual machines for routing. At 504, the virtual switch creates a data buffer. At 506, the virtual switch determines whether a data packet is of type that does not use a header, e.g., EQDIO. If so, e.g., the data packet is of EQDIO type, at 508, the virtual switch creates a header having a predetermined byte size, for example, of size x20 bytes. At 510, the data packet is copied starting from offset of byte size, e.g., x20 byte offset into the data buffer. If at 506, the virtual switch determines that the data packet is of type that uses a header, e.g., QDIO, at 512, the virtual switch copies the data packet into the data buffer, beginning at the starting address of the data buffer (i.e., no offset). At 514, a message block (data structure) that includes the address of the data buffer is placed on a virtual switch's processing queue. At 516, the virtual switch signals or notifies its backend hardware to start taking the data packets placed on its processing queue. In the scenario described in this figure, the hardware is a device that implements QDIO architecture.

In a different scenario in which the destination for a data packet, e.g., a hardware device implemented to take EQDIO type data packet, if a received data packet is of type QDIO, header bytes are removed by placing the buffer address offset by the header bytes (e.g., message block that includes the address of the data buffer offset by the header bytes) into the processing queue.

In some embodiments, the operations or functions of the virtual switch are performed by a controller or a control processor, e.g., running hypervisor.

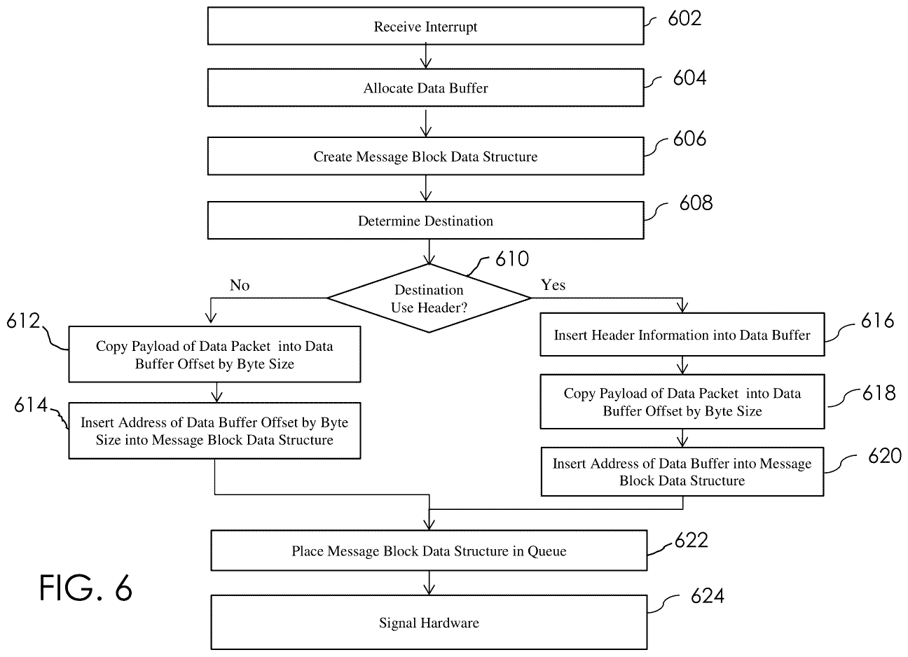

FIG. 6 is a flow diagram illustrating a virtual switch processing flow in some embodiments. The method allows multiple device types to connect to same virtual switch. At 602, a virtual switch receives an interrupt signal that signals a virtual switch to process a data packet that is input to the virtual switch. The data packet, e.g., is received from one or more virtual machines for routing, and is queued in a queue for processing.

At 604, the virtual switch allocates a data buffer in a memory space within the virtual switch. For example, the memory space is accessible by the virtual switch.

At 606, the virtual switch creates a message block data structure. The message block data structure, e.g., NDMBK block described above, is also created or allocated within the memory space associated with the virtual switch, for example, where the virtual switch can access it.

At 608, the virtual switch determines a destination device for the data packet. The destination device can be a backend hardware device of the virtual switch.

At 610, the virtual switch determines whether the destination device processes data packet with headers.

At 612, responsive to determining that the destination device processes data packets without headers, e.g., EQDIO mode, the virtual switch copies a payload of the data packet without header information into the data buffer offset by a predetermined byte size (e.g., address=data buffer address+offset of predetermined byte size). For example, the destination device implements enhanced queued direct input/output architecture that uses data packets without headers. In some embodiments, the predetermined byte size is x20 bytes (32 bytes). At 614, the virtual switch also inserts an address of the data buffer offset by the predetermined byte size into the message block data structure. In this way, a device that accesses this address will see the data packet without a header.

At 616, responsive to determining that the destination device processes data packets with headers, e.g., QDIO mode, the virtual switch inserts a header information associated with the data packet into the data buffer at the starting address of the data buffer. For example, the destination device implements queued direct input/output architecture that uses data packets with headers. At 618, the virtual switch also copies the payload of the data packet into the data buffer offset by the predetermined byte size. At 620, the virtual switch inserts the address of the data buffer into the message block data structure. In this way, a device that accesses this address will see the data packet starting with a header.

At 622, the virtual switch queues the message block data structure into a processing queue of the virtual switch.

At 624, the virtual switch signals the destination device to route the data packet by processing the message block data structure in the processing queue.

In some embodiments, the virtual switch determines a type of the data packet that is received into the virtual switch, for example, whether an incoming data packet has a header. Responsive to determining that the type of the data packet is of type that uses a header, and responsive to determining that the destination device processes data packets with headers, the virtual machine copies the entire data packet (e.g., including the header and payload) into the data buffer. For example, inserting of the header information associated with the data packet at the starting address of the data buffer and copying of the payload of the data packet into the data buffer offset by the predetermined byte size, can be performed by copying the entire data packet at the starting address of the data buffer. In this scenario, the virtual machine inserts the address of the data buffer into the message block data structure.

The virtual machine also can provide compacting of the message block data structure by storing multiple data buffer addresses respectively associated with multiple data packets based on the data sizes of the multiple data packets, for example, as described above.

As described above, techniques described herein allow multiple device types to connect to a same virtual switch. A virtual switch receives packets into a data buffer with header data area defined to create new formats. For example, there is always a space of number of bytes (e.g., x20 bytes) in the data buffer, e.g., starting at the beginning address of the data buffer. A virtual switch determines data packet's destination location and supported format in use by a network, and creates any necessary header data (e.g., QDIO) into a data buffer. Data packets are placed on processing queue for virtual switch to process. A virtual switch also compacts data from guest storage blocks into virtual switch storage blocks. A virtual switch uses a data buffer address plus (+) header size bytes, e.g., x20 bytes, as a storage block page when EQDIO (i.e., no header used) queue is determined. If QDIO type is determined, a virtual switch uses entire data buffer. A virtual switch supports EQDIO development while working on QDIO hardware.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in some embodiments” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving an interrupt that signals a virtual switch to process a data packet that is input to the virtual switch;
allocating a data buffer in a memory space associated with the virtual switch;
creating a message block data structure;
determining a destination device for the data packet;
responsive to determining that the destination device processes data packets without headers, copying a payload of the data packet without header information into the data buffer offset by a predetermined byte size, and inserting an address of the data buffer offset by the predetermined byte size into the message block data structure;
responsive to determining that the destination device processes data packets with headers, inserting header information associated with the data packet into the data buffer at the starting address of the data buffer, copying the payload of the data packet into the data buffer offset by the predetermined byte size, and inserting the address of the data buffer into the message block data structure;
queuing the message block data structure into a processing queue of the virtual switch; and
signaling the destination device to route the data packet by processing the message block data structure in the processing queue.

2. The method of claim 1, wherein the destination device implements input/output architecture that uses data packets without headers.

3. The method of claim 1, wherein the destination device implements input/output architecture that uses data packets with headers.

4. The method of claim 1, further including determining a type of the data packet that is received into the virtual switch.

5. The method of claim 4, wherein responsive to determining that the type of the data packet is of type that uses a header, and responsive to determining that the destination device processes data packets with headers, the inserting header information associated with the data packet into the data buffer at the starting address of the data buffer, and the copying the payload of the data packet into the data buffer offset by the predetermined byte size, includes copying the data packet into the data buffer.

6. The method of claim 1, further including compacting the message block data structure by storing multiple data buffer addresses respectively associated with multiple data packets based on the data sizes of the multiple data packets.

7. The method of claim 1, wherein the predetermined byte size is 32 bytes.

8. A computer program product comprising:
one or more computer-readable storage media; and
program instructions stored on the one or more storage media to perform operations comprising:
receiving an interrupt that signals a virtual switch to process a data packet that is input to the virtual switch;
allocating a data buffer in a memory space associated with the virtual switch;
creating a message block data structure;
determining a destination device for the data packet;
responsive to determining that the destination device processes data packets without headers, copying a payload of the data packet without header information into the data buffer offset by a predetermined byte size, and inserting an address of the data buffer offset by the predetermined byte size into the message block data structure;
responsive to determining that the destination device processes data packets with headers, inserting header information associated with the data packet into the data buffer at the starting address of the data buffer, copying the payload of the data packet into the data buffer offset by the predetermined byte size, and inserting the address of the data buffer into the message block data structure;
queuing the message block data structure into a processing queue of the virtual switch; and
signaling the destination device to route the data packet by processing the message block data structure in the processing queue.

9. The computer program product of claim 8, wherein the destination device implements input/output architecture that uses data packets without headers.

10. The computer program product of claim 8, wherein the destination device implements input/output architecture that uses data packets with headers.

11. The computer program product of claim 8, wherein the operations further comprise:
determining a type of the data packet that is received into the virtual switch.

12. The computer program product of claim 11, wherein responsive to determining that the type of the data packet is of type that uses a header, and responsive to determining that the destination device processes data packets with headers, the inserting header information associated with the data packet into the data buffer at the starting address of the data buffer, and the copying the payload of the data packet into the data buffer offset by the predetermined byte size, includes copying the data packet into the data buffer.

13. The computer program product of claim 8, wherein the operations further comprise:
compacting the message block data structure by storing multiple data buffer addresses respectively associated with multiple data packets based on the data sizes of the multiple data packets.

14. The computer program product of claim 8, wherein the predetermined byte size is 32 bytes.

15. A computer system comprising:
a processor set;
a set of one or more computer-readable storage media;
program instructions, collectively stored in the set of one or more computer-readable storage media, for causing the processor set to perform the following computer operations:
receiving an interrupt that signals a virtual switch to process a data packet that is input to the virtual switch;
allocating a data buffer in a memory space associated with the virtual switch;
creating a message block data structure;
determining a destination device for the data packet;
responsive to determining that the destination device processes data packets without headers, copying a payload of the data packet without header information into the data buffer offset by a predetermined byte size, and inserting an address of the data buffer offset by the predetermined byte size into the message block data structure;
responsive to determining that the destination device processes data packets with headers, inserting header information associated with the data packet into the data buffer at the starting address of the data buffer, copying the payload of the data packet into the data buffer offset by the predetermined byte size, and inserting the address of the data buffer into the message block data structure;
queuing the message block data structure into a processing queue of the virtual switch; and
signaling the destination device to route the data packet by processing the message block data structure in the processing queue.

16. The system of claim 15, wherein the destination device implements input/output architecture that uses data packets without headers.

17. The system of claim 15, wherein the destination device implements input/output architecture that uses data packets with headers.

18. The system of claim 15, wherein the computer operations further comprise:
determining a type of the data packet that is received into the virtual switch.

19. The system of claim 18, wherein responsive to determining that the type of the data packet is of type that uses a header, and responsive to determining that the destination device processes data packets with headers, the inserting header information associated with the data packet into the data buffer at the starting address of the data buffer, and the copying the payload of the data packet into the data buffer offset by the predetermined byte size, includes copying the data packet into the data buffer.

20. The system of claim 15, wherein the computer operations further comprise:
compacting the message block data structure by storing multiple data buffer addresses respectively associated with multiple data packets based on the data sizes of the multiple data packets.
